(19) United States
(12) Patent Application Publication
(10) Pub. No.: US 2010/0272521 A1
(43) Pub. Date: Oct. 28, 2010

(54) LATHE TOOLHOLDER INCORPORATING SIDE RAKE AND BACK RAKE

(76) Inventor: David L. Wimberley, Winchester, VA (US)

Correspondence Address: ROBERT PLATT BELL;REGISTERED PATENT ATTORNEY, P.O. BOX 13165, Jekyll Island, GA, 31527, US

(21) Appl. No.: 12/429,160

(22) Filed: Apr. 23, 2009

(51) Int. Cl. B26D 1/00

(52) U.S. Cl. 407/91

(57) ABSTRACT

A holder for a cutting bit of metal-cutting material, typically employed in a metal-cutting lathe, incorporates fixed side rake and fixed back rake. The invention makes use of straight tool bits of uniform cross-section that are much longer than they are wide. This invention allows for substantially simplified sharpening of the bit, and in one embodiment substantially simplified adjustment of the height of the cutting tip of the bit. The sharpening procedure allows for much more efficient use of the tool bit material as compared to conventional toolholders and sharpening procedures. Preferred embodiments of the present invention allow for easily producing a bit geometry that will both turn and face without adjusting the position of the toolholder. One embodiment places the tool bit in a highly unorthodox “nearly axial” orientation such that the axis of the bit is fairly close to parallel to the axis of the lathe. This nearly axial embodiment is particularly suitable for use with quick-change tool posts and turret type tool posts.

The present invention relates to toolholders for use with metal-cutting lathes and the like. In particular, the present invention is directed towards a toolholder with a cutting bit of high-speed steel, carbide, or other material typically employed in a metal-cutting lathe. The holder incorporates fixed side rake and fixed back rake.

### BACKGROUND OF THE INVENTION

High-speed steel tool bits have been used in machine tools for about a century, and a lot of ingenuity has been brought to bear on their use. The following U.S. patents and products are deemed relevant to the Background of the present invention.

Jackson, U.S. Pat. No. 687,237, issued Nov. 26, 1901 and incorporated herein by reference, discloses a lathe toolholder that uses, and can only use, a nonstandard tool bit of semicircular cross section. This toolholder features a fixed back rake and a variable side rake. This toolholder is apparently presented to the work in the conventional matter, perpendicular to the axis of the work, and may be used to cut right to left or left to right by adjusting the side rake whereas the present invention uses standard tool bit, incorporates fixed side rake, and is suitable only for cutting in one direction.

Tucker, U.S. Pat. No. 3,382,746, issued May 14, 1968 and incorporated herein by reference, discloses a lathe toolholder that incorporates no fixed rake. It does, however, present the tool bit at about a 35° angle from perpendicular to the axis of the work piece. Looking down on the tool that, the angle between the cutting edge of the principal flank, and the upper edge of the auxiliary flank is less than 90°, allowing the bit to both turn and face. (This embodiment is also common on many carbide inserts that are designed to both turn and face).

Steffes, U.S. Pat. No. 2,577,043, issued Dec. 4, 1951 and incorporated herein by reference, discloses a lathe toolholder that presents the tool bit at an angle to the work piece to significant advantage. The orientation of the bit is about 15° from perpendicular looking from the top, and about 17° from the perpendicular looking from the side. This latter deviation from perpendicular looks like built-in back rake, but the presumption in this tool design is that the upper surface of the tool is to be dressed. Sharpening is produced by creating facets on the end of the tool bit. This method of sharpening is simpler than the method that must be employed to obtain the geometry shown in Prior Art FIGS. 1A-1G in the present application.

Krenzer, U.S. Pat. No. 4,525,108, incorporated herein by reference, discloses a cutter and method for gear manufacture which is not a lathe toolholder. It is a cutter head assembly in a gear-cutting machine. Krenzer discloses a type of milling machine in which the cutter moves on a revolving holder and the work remains stationary whereas in a lathe, the work revolves and the cutter is more or less fixed, moving only relatively slowly in translation. (In a lathe, the cutting force is predominantly determined by the rotation of the piece against the tool rather than the movement of the tool against the work.) Krenzer incorporates both a fixed side rake and a fixed back rake, although the nomenclature is slightly different because the application is different. The term “side rake” is used as it is in the present application. Instead of back rake, the term “hook angle” is used. The rake face is called the front face. In sharpening, the front face is left undisturbed, as is the rake face in the present invention. The tool is more or less perpendicular to the axis of rotation of the toolholder; this is akin to the standard presentation of a lathe tool bit. This invention differs from the present invention in that it is a toolholder for a specialized milling machine rather than for a lathe. Furthermore, it is incorporates specific geometry for a specific task. Sharpening of the bit in this application would presumably be done on a specialized machine, and thus ease of sharpening is less of an issue than it is in the present invention.

Lindgren, U.S. Pat. No. 3,691,884, issued Sep. 19, 1972 and incorporated herein by reference, is an interesting case. This is an example of the unorthodox but relatively well-known approach of presenting the tool bit in a nearly tangential manner, the tool bit being more or less vertical in contrast to the typical more or less horizontal orientation. In this embodiment, the relief angles are fixed and the rake angle is ground to suit. One advantage of this design is that almost all of the sharpening is accomplished by creating one facet on the end of the tool bit. Lindgren relates to the present invention only in terms of the ease with which the bit may be sharpened. Fountain, U.S. Pat. No. 4,137,001, issued Jan. 30, 1979 and incorporated herein by reference, uses a nonstandard tool bit or a standard bit that has been ground to establish a fixed side rake along the entire length of the tool bit.

Thuerwachter, U.S. Pat. No. 2,936,679, issued May 17, 1960 and incorporated herein by reference, uses a nonstandard tool bit with built-in back rake. Kus, U.S. Pat. No. 3,820,211, issued Jun. 28, 1974 and incorporated herein by reference, uses a special curved tool bit with built-in side rake for both left and right cutting. Grungras, U.S. Pat. No. 3,889,331, issued Jun. 17, 1975 and incorporated herein by reference, incorporates a tool bit of special cross section. Mundy, U.S. Pat. No. 3,955,448, issued May 11, 1976 and incorporated herein by reference, does not include any built-in rake. In Spear, U.S. Pat. No. 4,278,370, issued Jul. 14, 1981 and incorporated herein by reference, the rake is ground into the cutting surface of a tool bit. Lin, U.S. Pat. No. 4,292,865, issued Oct. 6, 1981 and incorporated herein by reference, uses the internal geometry of a carbide insert to establish whatever back rake is desired. The side rake is automatically adjusted using “in-process force feedback”.

Pedersen, U.S. Pat. No. 5,305,558, issued Apr. 26, 1994 and incorporated herein by reference, describes a method of sharpening cutting blades (tool bits) that is not relevant to the present invention. Blakesley, U.S. Pat. No. 5,477,755, issued Dec. 26, 1995 and incorporated herein by reference, describes a special profile of cutting blade in a gear-cutting machine. St. Jean, U.S. Pat. No. 4,202,651, issued May 13, 1980 and incorporated herein by reference, concerns a method of clamping a tool bit only. Lee, U.S. Pat. No. 4,539,875, issued Sep. 10, 1985 and incorporated herein by reference, describes a self-sharpening metal cutting tool that includes no fixed side or back rake. MacKew, U.S. Pat. No. 3,543,364, issued Dec. 1, 1970 and incorporated herein by reference, involves a profile cutter with no fixed side or back rake. Freidman, U.S. Pat. No. 5,947,648, issued Sep. 7, 1999 and incorporated herein by reference, describes a lathe cut-off tool that uses a particular method of constraining a machining insert that would typically be made of tungsten carbide. Back rake is built into this toolholder. Lynch, U.S. Pat. No. 3,748,710, issued Jul. 31, 1973 and incorporated herein by reference, uses a carbide tool bit of nonstandard, specifically dovetail, cross section. Back rake is built in to this toolholder.

In addition to U.S. patents, it is important to discuss common commercial practices that are relevant to the present invention. Toolholders that employ carbide inserts are significantly different from the present invention because of the geometry of the cutting bit (carbide insert versus long tool bit of uniform cross section). Some carbide inserts have no built-in relief angle. The advantage of this embodiment is that the insert may be turned over and used on the other side, but the corresponding disadvantage is increased power consumption and other problems associated with negative rake. Toolholders for such inserts must provide built-in negative rake to establish a relief angle. Carbide insert toolholders that are designed to allow the operator to face or turn in the same orientation must incorporate both negative side rake and negative back rake, and thus share something with the present invention, that being the provision of built-in fixed side rake and back rake although the fixed rake angles in the current invention may be positive. Traditional forged toolholders for high-speed steel tool bits are designed to be used with a lantern style tool post often have built-in back rake.

### SUMMARY OF THE INVENTION

In the present invention, a relatively long and slender straight tool bit of uniform cross section is clamped in a toolholder such that both side rake and back rake are fixed. In most embodiments the tool bit is not presented to the work perpendicularly as is traditionally the case. In a preferred embodiment the tool bit is presented in a nearly axial orientation.

The present invention comprises a holder for a cutting bit of high-speed steel, carbide, or other cutting material typically employed in a metal-cutting lathe. The holder incorporates fixed side rake and fixed back rake. The invention may allow the use of standard straight tool bits of uniform cross-section that are much longer than they are wide. This invention allows for substantially simplified sharpening of the bit, and in one embodiment substantially simplified adjustment of the height of the cutting tip of the bit. The sharpening procedure allows for much more efficient use of the tool bit material as compared to conventional toolholders and sharpening procedures. Preferred embodiments of the present invention allow for producing a bit geometry that will both turn and face without adjusting the position of the toolholder. One embodiment places the tool bit in a highly unorthodox “nearly axial” orientation such that the axis of the bit is fairly close to parallel to the axis of the lathe. This nearly axial embodiment is particularly suitable for use with quick-change tool posts and turret type tool posts. A second preferred embodiment places the tool bit in a more conventional position but, against convention, orients the shank of the tool parallel to the axis of the lathe.

In the examples presented, the tool bit is held in a slot or square hole by setscrews. This is a very common and easy-to-manufacture approach. A myriad of other means of securing the tool bit are discussed in the U.S. patent literature and are available in the public domain.

The present invention concerns the basic shape and orientation of the toolholder and its bit, not the method by which the tool bit is secured. It is anticipated that the primary market for this invention may be amateur machinists, who may use high speed steel cutting tools. The invention would enable an inexperienced operator to easily produce a bit with a highly effective cutting geometry. Many amateur machinists find it quite difficult to effectively and efficiently grind conventional tool bits. The present invention may also find use on manual lathes in commercial machine shops.

The tool bits used may predominantly be made of high-speed steel. A common example of such a high-speed steel bit may be 3/16 inch square in cross-section and 2½ inches long. In the smaller standard sizes, the length is typically 8 to 20 times greater than the width. Although the cross sections are typically square, the cross section may be rectangular, triangular, circular and other shapes. All of the illustrated embodiments herein feature tool bits of square cross section, although the present invention may be adapted to other cross-sectional embodiments.

The following definitions of terms are used in the present application. In a lathe a typically cylindrical work piece is turned around its axis so that the axis of the work piece is the same as the axis of the lathe. Material is removed by presenting non-rotating cutting tools to the surface of the work piece. Turning is removing material by moving the tool parallel to the axis of the lathe thus reducing the diameter of the piece. Facing is removing material from the end of the piece by moving the tool perpendicular to the axis of the lathe.

### BRIEF DESCRIPTION OF THE DRAWING

FIG. 1A is a perspective view of a Prior Art turning tool, illustrating the geometry of a typical Prior Art turning lathe tool.

FIG. 1B is a top view of a Prior Art turning tool illustrating section lines B-B.

FIG. 1C is a cross-section view along the lines B-B of FIG. 1B.

FIG. 1D is a top view of a Prior Art turning tool, illustrating the geometry of a typical Prior Art turning lathe tool.

FIG. 1E is a top view of a Prior Art turning tool illustrating section lines C-C.

FIG. 1F is a cross-section view along the lines C-C of FIG. 1E.

FIG. 1G is a top view of a Prior Art turning tool, illustrating the geometry of a typical Prior Art turning lathe tool as it is machining a cylindrical work piece.

FIG. 2A is perspective view of a tool bit ground on the left end, illustrating an easy-to-grind facet.

FIG. 2B is perspective view of a tool bit ground on the left end, illustrating a difficult-to-grind long or shallow facet.

FIG. 2C is perspective view of a tool bit ground on the left end, illustrating the creation of a surface such as the traditional rake face illustrated in FIGS. 1A, 1B, 1D, 1E, and 1G.

FIG. 3A is a top view of a first embodiment of a toolholder of the present invention having a plan angle of 20°.

FIG. 3B is a side view of a first embodiment of a toolholder of the present invention having a plan angle of 20°.

FIG. 3C is an enlarged view of detail B of FIG. 3A illustrating details of the cutting tool geometry.

FIG. 4A is a top view of a second embodiment of a toolholder of the present invention having a plan angle of 20°, illustrating an unorthodox version of this toolholder.

FIG. 4B is a side view of a second embodiment of a toolholder of the present invention having a plan angle of 20°, illustrating an unorthodox version of this toolholder.

FIG. 5A is a top view of a third embodiment of a toolholder of the present invention having a plan angle of 20°, illustrating a compact design that may use a shortened tool bit.

FIG. 5B is a side view of a third embodiment of a toolholder of the present invention having a plan angle of 20°, illustrating a compact design that may use a shortened tool bit.

FIG. 6A is a top view of a fourth embodiment of a toolholder of the present invention having a plan angle of 45°.

FIG. 6B is a side view of a fourth embodiment of a toolholder of the present invention having a plan angle of 45°.

FIG. 7A is a top view of a fifth embodiment of a toolholder of the present invention having a plan angle of 70°.

FIG. 7B is a side view of a fifth embodiment of a toolholder of the present invention having a plan angle of 70°.

FIG. 8A is a top view of a sixth embodiment of a toolholder of the present invention, identical to that shown in FIGS. 7A and 7B except that the tool that has been sharpened to produce a side cutting edge angle of 20°.

FIG. 8B is a side view of a sixth embodiment of a toolholder of the present invention, identical to that shown in FIGS. 7A and 7B except that the tool that has been sharpened to produce a side cutting edge angle of 20°.

FIG. 8C is an enlarged view of detail B of FIG. 8A illustrating details of the cutting tool geometry.

FIG. 9A is a top view of a seventh embodiment of a toolholder of the present invention, identical to that shown in FIGS. 7A and 7B except that the tool bit is facing rather than turning and has been sharpened to produce an end cutting edge angle of 20°.

FIG. 9B is a side view of a seventh embodiment of a toolholder of the present invention, identical to that shown in FIGS. 7A and 7B except that the tool bit is facing rather than turning and has been sharpened to produce an end cutting edge angle of 20°.

FIG. 9C is an enlarged view of detail B of FIG. 9A illustrating details of the cutting tool geometry.

FIG. 10A is a top view of an eighth embodiment of a toolholder of the present invention, identical to that shown in FIGS. 7A and 7B except that the tool is facing rather than turning.

FIG. 10B is a side view of an eighth embodiment of a toolholder of the present invention, identical to that shown in FIGS. 7A and 7B except that the tool is facing rather than turning.

FIG. 10C is an enlarged view of detail B of FIG. 10A illustrating details of the cutting tool geometry.

FIG. 11 is a top view illustrating the plan angle of the tool in the present invention.

FIG. 12 depicts a plane, henceforth called the rake plane, which is parallel to the rake face, 101 defined in FIG. 1A.

FIG. 13 is a plan (overhead) view illustrating a rake plane 1310 identical with the rake plane shown in FIG. 12 upon which are placed three tool bits of plan angles 20, 45, and 70.

### DETAILED DESCRIPTION OF THE INVENTION

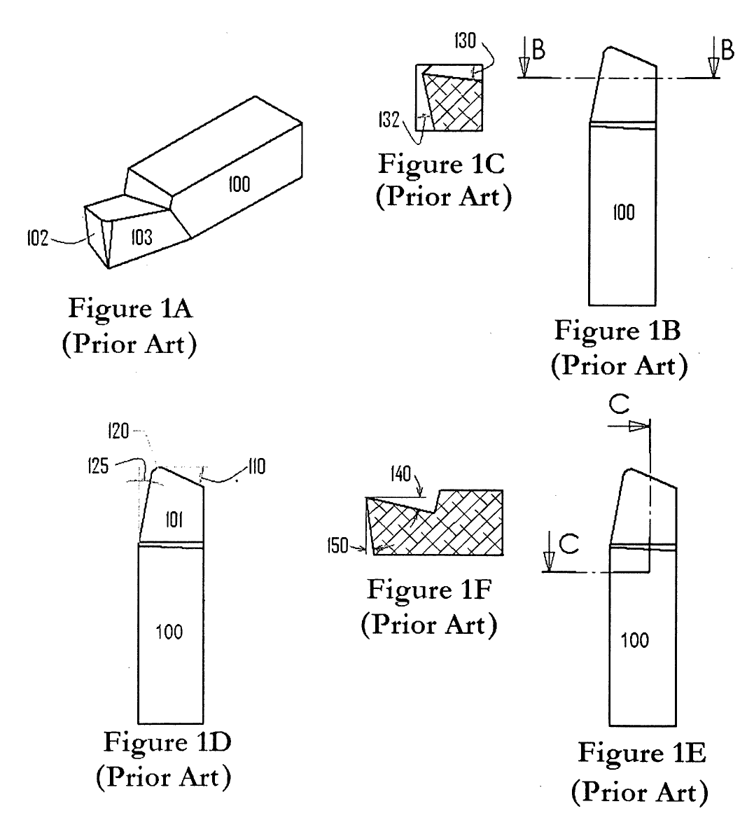

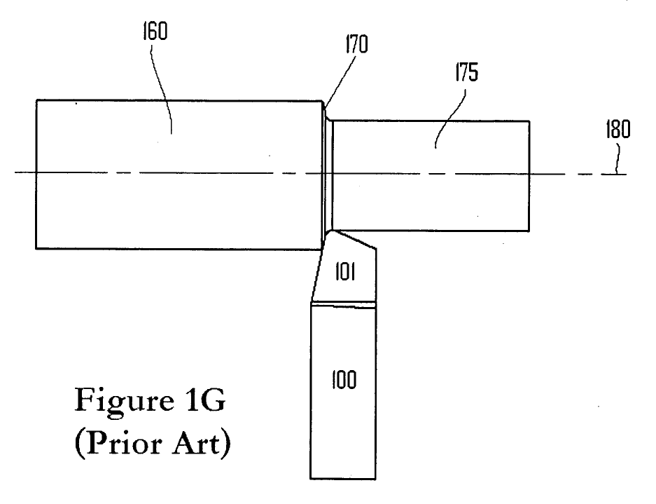

FIG. 1A is a perspective view of a Prior Art turning tool, illustrating the geometry of a typical Prior Art turning lathe tool. FIG. 1B is a top view of a Prior Art turning tool illustrating section lines B-B. FIG. 1C is a cross-section view along the lines B-B of FIG. 1B. FIG. 1D is a top view of a Prior Art turning tool, illustrating the geometry of a typical Prior Art turning lathe tool. FIG. 1E is a top view of a Prior Art turning tool illustrating section lines C-C. FIG. 1F is a cross-section view along the lines C-C of FIG. 1E. FIG. 1G is a top view of a Prior Art turning tool, illustrating the geometry of a typical Prior Art turning lathe tool as it is machining a cylindrical work piece.

Referring to FIGS. 1A-1G, rake face 101 is illustrated, having side cutting angle 125, which in this example may be approximately 11 degrees. The end cutting edge angle 110 in this example may be approximately minus 24 degrees. The negative end cutting edge angle provides clearance when turning. Conventional discussions of tool bit geometry consider only bits that are suitable for turning from right to left, and the end cutting edge angle 110 would be considered positive. Discussion of this invention will include consideration of tool bits that are capable of both turning from right to left and facing the right end of the work piece. Therefore, it will be convenient to refer to cutting edge angles that provide relief as negative and those that provide a positive cutting edge angle when they are cutting material, as positive.

The end of tool 100 may include a nose radius 120, rather than a sharp point. The angles shown here are by way of example only, for a Prior Art tool bit 100, to illustrate the nomenclature used to identify the various faces and angles of such a tool bit. Referring to FIG. 1C, side rake angle 130 is shown, which in this example, may be approximately 7 degrees. Side relief angle 132 may be approximately 13 degrees. Again, the angles shown here are by way of example only, for a Prior Art tool bit 100, to illustrate the nomenclature used to identify the various faces and angles of such a tool bit.

Referring to FIG. 1F, back rake angle 140 is illustrated, which may be approximately 13 degrees. End relief angle 150 may be approximately 8 degrees in this example. Again, the angles shown here are by way of example only, for a Prior Art tool bit 100, to illustrate the nomenclature used to identify the various faces and angles of such a tool bit.

As illustrated in FIGS. 1A-1E, the tool bit 100 of the Prior Art is generally ground down at the end portion to provide cutting edges with prescribed angles, so as to allow the cutting tool point to cut efficiently (with minimal effort) while preserving the sharp edge, as discussed in connection with FIG. 1G. FIG. 1G is a top view of a Prior Art turning tool, illustrating the geometry of a typical Prior Art turning lathe tool as it is machining a cylindrical work piece. Referring to FIGS. 1A-1G, the axis of the tool bit 100 is typically perpendicular to the axis 180 of the lathe. Bit 100 shown is designed for turning from right to left and not for facing. In the example of FIG. 1G, tool bit 100 may turn bar stock 160 to reduce the diameter of the bar stock as shown in portion 175. The view of FIG. 1G is looking down at the bar stock 160 as it is turning in a lathe. When tool bit 100 is used to face (something not actually possible with the specific geometry of example tool bit 100 illustrated in FIGS. 1A-1G), auxiliary flank 102 of FIG. 1A becomes the principal flank.

Sharpening a tool bit to establish the type of geometry shown in FIGS. 1A-1G is fairly complicated. Creating the back rake is particularly problematic. Each time the tool bit is re-sharpened the shape of the tip changes. Creating back rake in this manner makes sharpening the tool bit complicated. In addition, it results in substantial waste of the tool bit, as the end of the bit must periodically be ground away after repeated sharpening has rendered the tip too weak, and a new cutting tip must be formed.

The present invention comprises a toolholder that holds the tool bit so that both the side rake and the back rake are built-in. That is, one side of the tool bit, unmodified, serves as the rake face. Only two facets need to be created, the principal flank and the auxiliary flank. The relief angle may be the same for each, for example 7°, in which case a single setup on a grinder that provides a 7° relief angle allows the operator to create the principal flank and the auxiliary flank very easily. Grinding a nose radius with the same relief angle is a simple matter. Other relief angles may be used within the spirit and scope of the present invention, as discussed herein. However, the thrust of the invention is to simplify grinding of the tool bit and thus simplify the sharpening process and reduce the amount of tool bit material lost in sharpening and grinding. Much of the geometry required for the tool bit faces is provided by the toolholder of the present invention, not by the grinding process, as in the Prior Art FIGS. 1A-G.

Incorporating fixed side rake and back rake may put a number of limitations on the uses to which the tool bit may be put. The present invention is designed to turn and to face, but not to plunge or profile. Reference books specify unique angles for side rake, back rake, and clearance angles for specific materials. Therefore one toolholder with fixed side and back rake may not have ideal geometry for many materials that may be machined. It is widely believed that a good machinist should be able to rapidly grind a tool bit that is optimized for a given material and cutting function.

On the other hand, there are many advantages to a tool bit holder that provides fixed side rake and back rake. The side relief and end relief angles of the tool bit may be made the same, substantially simplify the grinding process. By far, the most difficult part of grinding a tool bit is creating the rake surface. In this design, the rake surface is the existing, factory-made surface of the tool bit, and requires no attention other than the removal, with an abrasive sharpening stone, of any built-up material or burr created by the grinding process. Other than drilling, boring, and cut-off operations, the vast majority of lathe operations are simple turning and facing. It may be necessary to do some plunging and profiling on occasion, and it is also sometimes necessary to cut from left to right. Nevertheless, a toolholder that incorporates rake angles that are a reasonable compromise for the materials typically being cut, and that can cut from right to left and face the right end of the work, may be used for the vast majority of turning and facing operations in many environments.

The present invention greatly simplifies the preparation by grinding of a high-speed steel tool bit. In use, the tool bit is normally held in the toolholder so that it protrudes a small amount, typically on the order of the thickness of the tool bit. In order to sharpen the bit using a toolholder of the present invention, the bit is loosened and extended from the toolholder, so that the end of the bit is about three quarters of an inch from the toolholder. This provides clearance so that the toolholder does not come in contact with the grinding surface. Using a grinding apparatus such as a disk sander or side-wheel grinder (often known as a carbide grinder) with a table set at an appropriate relief angle, the operator simply orients the toolholder to establish the side-cutting angle and grinds the principal flank. The operator then orients the toolholder to establish the end-cutting angle and grinds the auxiliary flank of the tool. (The so-called auxiliary flank becomes the principal flank when facing rather than turning.) The operator next grinds a radius on the nose of the tool using the same relief angle. Finally, the operator removes the bit from the holder and uses a sharpening stone to hone the tool as he sees fit. Honing serves to remove burrs formed by the grinding process and to polish the surfaces created. After the bit has been prepared, it is returned to its proper position in the holder for use.

The rake face is the part of a tool that comes in contact with the material being removed from the workpiece, and this material must slide off the rake face. It is therefore desirable to have a polished or smooth rake face for efficient cutting. The fact that, in this invention, an undisturbed side of the tool bit becomes the rake face confers benefits beyond the fact that the rake face does not have to be created by grinding. The side of the tool bit is ground flat during its manufacture, and sometimes is even somewhat polished. Even a roughly ground surface can be easily polished, leaving a smooth rake face that would be difficult to emulate in a conventional hand-ground tool bit such as that shown in FIGS. 1A through 1G.

Because of the built-in rake angles, the farther the bit protrudes, the higher its nose may be. Two of the preferred embodiments of the toolholder of the present invention make it very easy to establish the stick-out or distance of protrusion. In these cases, a standard distance is established, using a spacer of fixed dimension, between a reference surface and the side of the toolholder. The reference surface may be the faced end of the work piece or another surface perpendicular to the axis of the lathe. The bit is then inserted into the toolholder and slid until it is both seated in the toolholder and touching the reference surface. The extreme ease of sharpening and establishing the height of the nose of the bit are a boon to novice and experienced operators alike.

The previous discussion illustrates how simple it is to sharpen a bit using the toolholder proposed in the present invention. In order to fully understand the relative ease of sharpening it is useful to discuss the problems associated with sharpening a tool bit that is presented in the conventional manner, perpendicular to the rotational axis of the work. For the purposes of the present invention, a “facet” is defined in order to facilitate this discussion. For the purposes of the present invention, a facet is produced when a solid object is severed by a single plane, and the smaller portion of the object divided by the plane is removed.

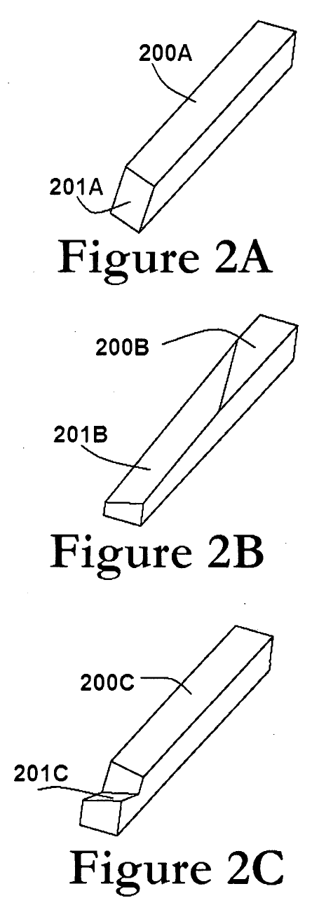

FIGS. 2A-C are perspective views of various tool bits, illustrating three tool bits, each ground on the left end. FIG. 2A shows an easy-to-grind facet such as used in the present invention. A simple facet such as this may be created by simply pressing the tool bit against a flat grinding surface such as provided by a disk sander or “carbide grinder” that provides a flat surface on the side of a special grinding wheel. FIG. 2B shows a more difficult-to-grind long or shallow facet. Such a facet might easily be produced with special equipment, but may be difficult to grind by hand.

FIG. 2C demonstrates the creation of a surface such as the traditional rake face illustrated in FIGS. 1A-G. In this case, two planes are required and the surfaces created are therefore, by the convention adopted herein, not facets. In order to create this geometry the tool bit must interact with the edge of the grinding wheel or other abrading surface. This requires more operator skill, and also requires that an edge of an abrading surface be accessible, which is not always the case.

In addition to being more difficult to create, geometries such as that shown at in FIG. 2C are very wasteful of the material of the tool bit. Each time such a surface is re-ground, the bit gets thinner, weaker, and different in shape. Eventually the end of the bit must be ground off and the process started again. In contrast, using the present invention, when a facet is dressed or re-ground the shape of the end of the bit remains the same and there is never any need to cut the end of the tool bit off and start over.

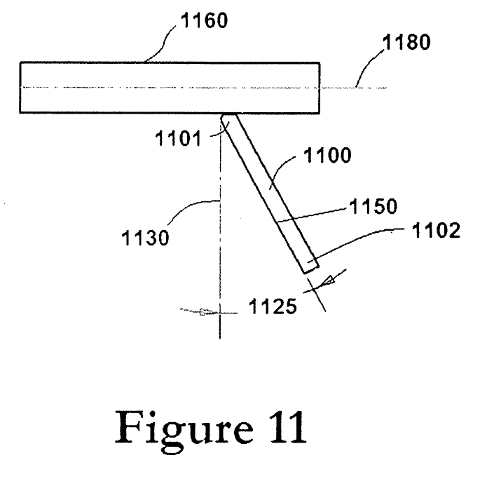

Discussion of the orientation of the tool bit is facilitated by the introduction of the term plan angle. FIG. 11 is a top or plan view (from above) illustrating the plan angle of a tool in the present invention. Element 1160 is the work piece. Line 1180 represents the axis of the lathe. Line 1130 represents a plane perpendicular to the axis of the lathe. Element 1100 is the tool bit. 1150 is an edge of the tool bit parallel to the axis of the tool bit. 1125 is the plan angle. Plan angle 1125 is the angle between the axis or edge 1150 of tool bit 1100 and the plane 1130 perpendicular to the axis of the lathe 1180 projected onto a horizontal plane, as illustrated in FIG. 11. It is a projected angle and may not be the actual angle between the axis of the tool and the perpendicular plane 1130. In toolholders that establish positive rake, the heel 1102 of the tool 1100 will generally be lower than its cutting tip 1101. This causes the actual angle between the axis or edge 1150 of the tool bit 1100 and the perpendicular plane 1130 to be somewhat less than the projected plan angle 1125.

If one is going to incorporate fixed side and back rake angles into a toolholder, it is very important to orient the tool bit in a way that is most advantageous. Conventionally, tool bits have a plan angle of zero. (The axis of the bit is perpendicular to that of the lathe, such as is illustrated in FIG. 1G.) One can create fixed side rake (by rotating the bit around its axis), and back rake (by pushing the heel end of the bit downward) but the results are of limited use. This geometry is only useful if a substantial positive side-cutting angle is present. If a side-cutting angle of 20°, for example, is desired this may be produced by the grinding procedure established above. Creating a side cutting angle of 20° establishes a relatively easy-to-grind facet. Creating a side-cutting angle of, for example, positive 5° requires the production of a shallow facet and is not as easy.

If the bit has a plan angle of zero, it can turn but it cannot face unless some sort of undercut, non-facet geometry is introduced. If the bit has a sufficiently large positive plan angle, it becomes possible to easily sharpen the bit such that a negative side cutting angle turns into an end cutting angle when facing. If negative side cutting and end cutting angles of, for example, −5° are established the tool can both turn and face. In general work, it is very convenient to be able to do both of these operations with the same tool and without reorienting the tool.

For the purposes of illustration, five versions of the toolholder itself are shown, although a number of other embodiments are possible within the spirit and scope of the present invention. For the purposes of the present application, only embodiments that allow the tool bit to be easily sharpened to facilitate both turning and facing are shown. Given this constraint, it is desirable to be able to grind the tool bit with simple non-shallow facets so that the side cutting and end cutting angles are about −5°. Orientations that allow for this cannot be too close to perpendicular or parallel to the axis of the lathe. Specifically, orientations that have plan angles of much less than 20° or more than 70° will require grinding a facet that is unnecessarily shallow and difficult to produce.

In order to demonstrate the range of potential toolholder geometries, toolholders having plan angles of 20°, 45°, and 70° are shown. The limiting plan angles of 20 and 70 are somewhat arbitrary figures and workable tool bits with plan angles somewhat smaller than 20° and somewhat larger than 70° may be produced. However, as noted above, if the plan angle is less than 20 degrees or greater than 70 degrees, the shallowness of the ground facets of the tool bit will increase, making the tool bit harder to grind and defeating the purpose of the invention.

For the sake of discussion, the illustrated embodiments in the present application are limited to toolholders that cut from right to left (the more common direction). In order to produce a toolholder that will cut from left to right the geometry of the bit and toolholder may be mirrored about a vertical plane. For the purposes of discussion, all but one embodiment are shown with a full length tool bit of square cross section, typically 2½ inches. It may be easier to produce a design that uses a shortened tool bit, but such a design may be intrinsically less economical in terms of bit consumption. Bits of square cross section are the most common and least expensive. Square bits serve to clearly illustrate the concepts involved. If a bit with a uniform cross-section other than square were to be used, the upper side that serves as the rake face would be oriented the same as the upper side of a square bit. A toolholder designed for use with such a bit would differ from one designed to be used with a square bit only in that it would conform to the non-square cross-section rather than to the square cross section of a square tool bit. For simplicity the toolholders in these illustrations adopt the rake geometry described below, that is, both side rake and back rake being about 14.43°.

As previously stated, the present application illustrates toolholders incorporating three plan angles. The embodiments with a plan angle of 20° are most similar to conventional toolholders. The embodiment with a plan angle of 45° is quite an unorthodox orientation. The version with a plan angle of 70 is an even more unorthodox orientation. In the drawings presented, the toolholder is shown from above, and from the side, looking toward the chuck end of the lathe. Side rake and back rake are established by moving the heel of the tool below the cutting tip of the tool, and (usually) twisting the tool around its axis.

Establishing the orientation in space of the tool bit substantially determines the shape of the toolholder, because it must conform to the particular orientation of the tool bit. The orientation of the bit is completely determined by establishing two entities, the plan angle, and the rake plane introduced below. The rake plane in turn is completely determined by the side rake and back rake angles.

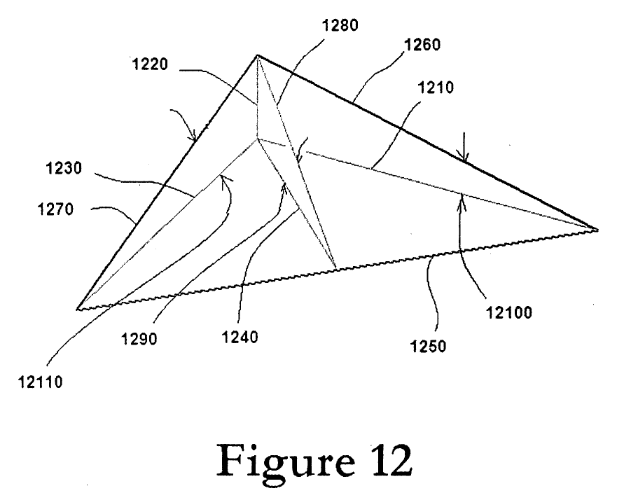

In order to understand the somewhat complex geometry involved with cutting tools, refer to FIG. 12. FIG. 12 depicts a plane, henceforth called the rake plane, which is parallel to the rake face, 101 defined in FIG. 1A. In FIG. 12, element 1210 is the horizontal axis of the lathe and element 1230 is a horizontal line perpendicular to 1210. 1240 is a horizontal line whose orientation is midway between that of 1210 and 1230. 1250 connects 1210 and 1230, which, in this drawing, are equal in length. 1250, 1260, and 1270, lie in a plane that is inclined to the horizontal plane, which includes 1210, 1230, and 1250. The intersection of the horizontal plane that includes 1210, 1230 and 1250 and the inclined plane occurs along 1250.

The angle between two planes is measured within a plane that is perpendicular to the line of intersection of the two planes. 1220, 1240, and 1280 lie in such a plane. Angle 1290 between 1240 and 1280 is the angle between the horizontal plane and the rake plane. In this illustration 1290 (the actual angle, not the projected angle) is 20°.

It is very desirable to be able to turn and face with a single tool in a single orientation. A tool that performs both of these functions is well served by a rake plane such as the one depicted in FIG. 12 that is symmetric with respect to the axis of the lathe and the horizontal line perpendicular to the axis of the lathe. Asymmetric geometries are possible and might be useful in specialized tools, but general-purpose tools are more likely to use a symmetric (or nearly symmetric) geometry such as shown here. The shown geometry is in fact, employed in all of the examples of the invention shown.

There is some variability in the definition of side rake and back rake. For the purpose of this application, side rake will be defined as the angle between the horizontal and the line produced by the intersection of the rake plane and a vertical plane parallel to the axis of the lathe. In this case, that the plane includes 1210, 1220, and 1260. The side rake, angle 12100 between 1210 and 1260 is, in this case, approximately 14.43°.

Back rake is defined in a similar way. It is the angle between the horizontal and the line produced by the intersection of the rake plane and a plane perpendicular to the axis of the lathe. In this case, such a plane is includes 1230, 1220, and 1270. The side rake, angle 12110 between 1230 and 1270 is, in this case, approximately 14.43°. These definitions of side rake and back rake are consistent with the definitions implied by FIGS. 1C and 1F.

The character of the rake plane is completely determined by the side rake 12100 and the back rake 12110. Recommended side rake angles for turning soft to fairly soft steel with high-speed steel tool bits may range from 8 to 20°. Recommended side rake angles for turning various aluminum alloys with high-speed steel tool bits may range from 15 to 35°. The side and back rake angles used in this example, of 14.43° represent a reasonable compromise if one expects to turn and face materials that range from fairly soft steel to various aluminum alloys. If a tool is dedicated to turning only or facing only, side rake and back rake may be unequal, creating an asymmetric rake plane. Toolholders dedicated to machining a particular material would have side rake and back rake angles dictated by the material being machined and the nature of the tool bit.

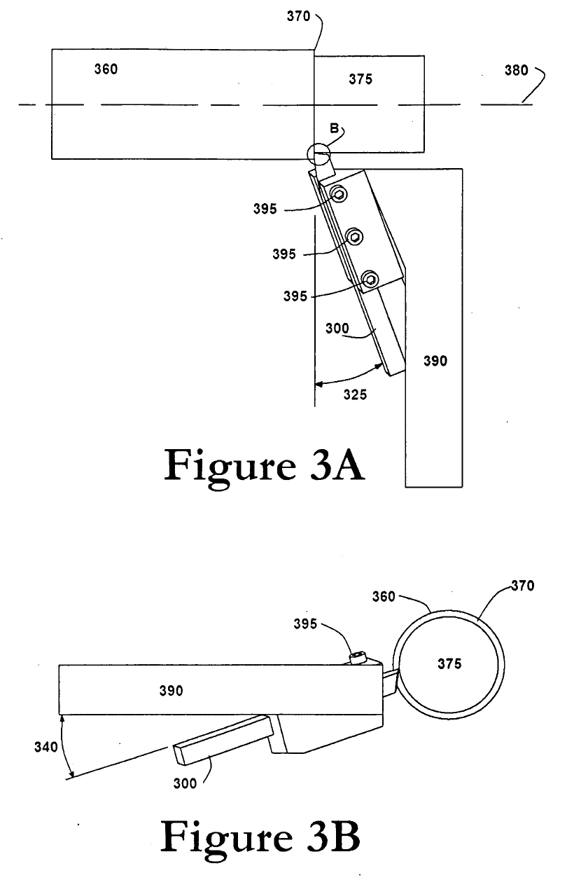

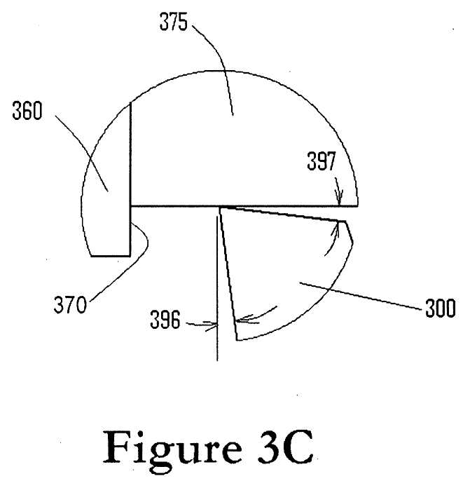

Increasing angle 1290 increases both side rake and back rake. Decreasing angle 1290 decreases both side rake and back rake. Prototypes employing a symmetric rake plane with an angle 1290 of 20° have demonstrated that this is a good compromise for cutting aluminum alloys and many steels. An angle 1290 of 20° should be commercially accepted, and has been used in the creation of the toolholders shown in FIGS. 3 through 10. It is not obvious, but the rake plane of all of these toolholders is identical, and therefore the cutting geometry is identical, assuming that the principal and auxiliary flanks are produced in a similar way.

As a demonstration of the fact that these toolholders, having widely variable plan angles, all have the same rake geometry, it is useful to show tool bits from these various toolholders in contact with a single rake plane.

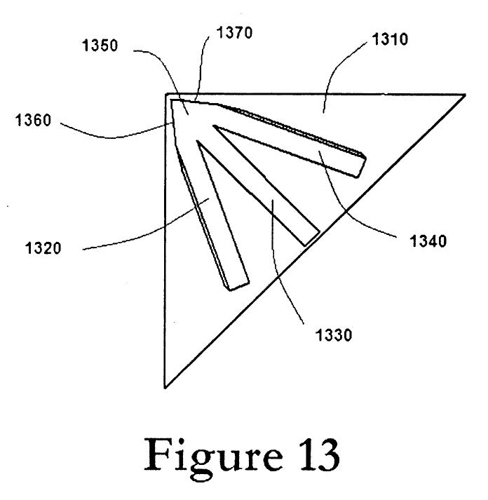

FIG. 13 is a plan (overhead) view illustrating a rake plane 1310 identical with the rake plane shown in FIG. 12. Three tool bits, 1320, 1330, and 1340, of different plan angles are each place on rake plane 1310 so that the under surfaces are completely in contact with plane 1310. These three bits are merged at the cutting end 1350 to demonstrate the fact that these bits are coplanar, and when sharpened similarly, the side-cutting edge 1360 and the end cutting edge 1370 will be aligned for each of the three bits.

FIG. 13 demonstrates that these three bit orientations, whereas they may look different in this drawing and certainly will look different when they are installed in a toolholder, have precisely the same cutting geometry. The bits shown are square in cross-section and the bottom surfaces are of course parallel to the top surfaces. Therefore the top surfaces are parallel to the rake plane in spite of the fact that this may appear not to be the case.

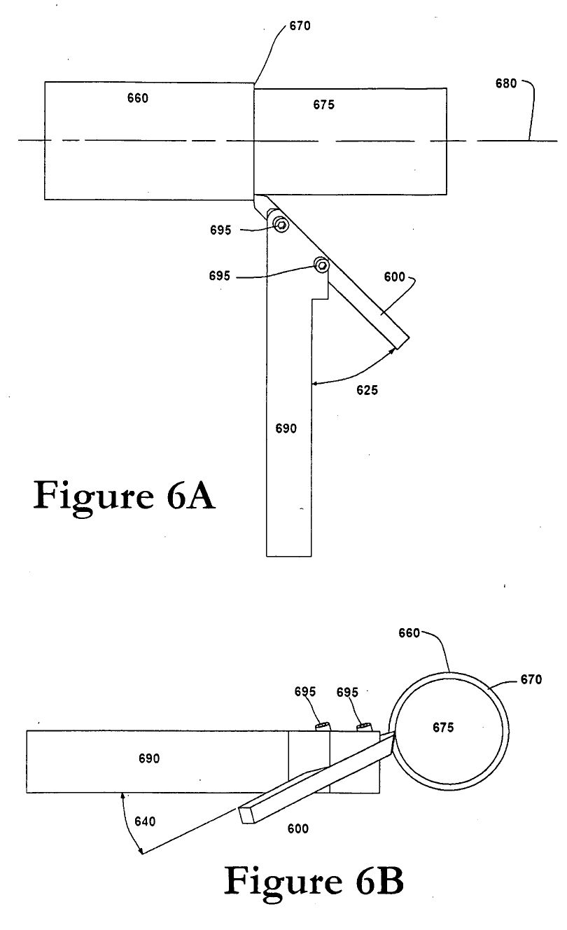

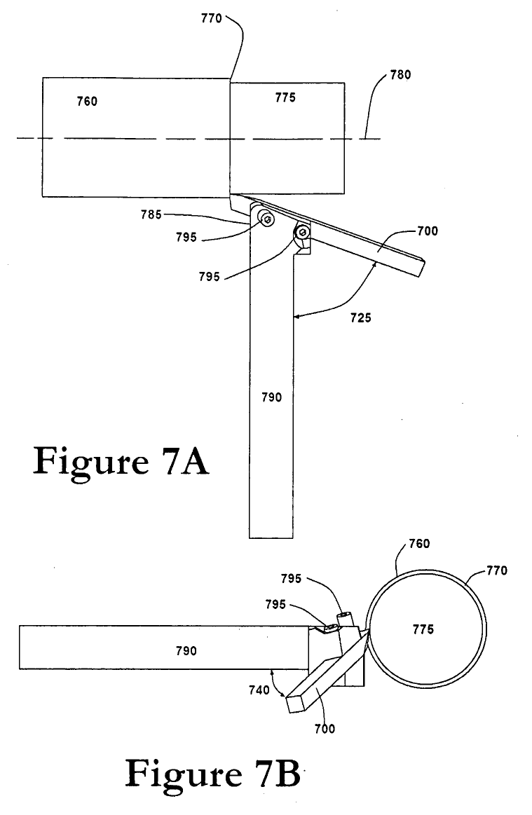

Tool bit 1320 has a plan angle of 20°. Tool bit 1330 has a plan angle of 45°. Tool bit 1340 has a plan angle of 70°. The specific orientation of each tool bit is determined by its plan angle and the nature of the rake surface, in this case a symmetric rake surface that yields equal side rake and back rake, that is inclined 20° from the horizontal. The orientation of tool bit 1320 is incorporated into the toolholders depicted in FIGS. 3A-C, 4A-B, and 5A-B. The orientation of tool bit 1330 is incorporated into the toolholder depicted in FIGS. 6A-B. The orientation of tool bit 1340 is incorporated into the toolholders depicted in FIGS. 7A-B, 8A-C, 9A-C, and 10A-C, as will be discussed in more detail below.

Each of the tool bits, 1320, 1330, and 1340 has the same cutting geometry, but the various plan angles influence how that geometry is created. Bit 1330 is tilted the most (its heel is depressed the most). In addition, it can be seen that bit 1330 is not rotated around its axis. Bit 1330 conforms to the rake plane surface by tilting but not rotating the bit. In contrast, bits 1320 and 1340 have heels that are depressed less than the heel of bit 1330. In order to conform to the rake plane, bits 1320 and 1340 must be rotated around their axes. Bit 1320 must be rotated clockwise and bit 1340 must be rotated counterclockwise.

FIGS. 3A and 3B illustrate a first embodiment of a toolholder of the present invention incorporating a plan angle 325 of 20° and a symmetric rake plane tilted 20° from horizontal. Referring to FIGS. 3A and 3B, the axis of the elongated base (shank) of toolholder 390 may be perpendicular relative to the axis 380 of the lathe. Angle 340 is about 19.34°. This is the angle between the horizontal plane and an axis or edge of the tool bit 300 projected onto a plane that is perpendicular to the axis of the lathe, or in the case of FIG. 3B, the plane of the paper. This angle is derivative in the sense that it is completely determined by the plan angle and the two rake angles. It is shown to better clarify the overall geometry of the toolholder. Tool bit 300 may be secured to toolholder 390 via setscrews 395 or the like. Bit 300 shown is designed for turning from right to left and for facing. In the example of FIGS. 3A and 3B, tool bit 300 is turning bar stock 360 to reduce the diameter of the bar stock as shown in portion 375. The cutting takes place at the transition 370 between the uncut bar stock 360 and the reduced portion 375.

Many machinists, both professional and amateur, use quick-change tool posts, turret type tool posts or tool blocks, which result in the toolholder being attached to a somewhat bulky, more or less cube-shaped attachment device that clamps the shank of the toolholder 390 and extends to the right of the toolholder. The invention is not limited to being used with quick-change tool posts, turret style tool post or tool blocks, but the examples illustrated may be suitable for such mountings. For the purposes of the present application the term “quick-change tool post” is used to refer to all three styles for convenience. Quick-change tool posts have replaceable units that hold toolholders such as the ones discussed herein. These replaceable units are unfortunately also called toolholders, creating some confusion. In this discussion, these replaceable units may be called tool blocks. The embodiment of FIGS. 3A and 3B illustrates a toolholder that may be used with a quick-change tool post but, compared to some other embodiments would result in the cutting tip being relatively distant from the center of the tool post. Ideally, the cutting tip should be as close as possible to the center of the tool post for rigidity and convenience of use. The embodiments shown in FIGS. 3A and 3B are rather bulky and may be somewhat difficult to manufacture compared to other embodiments.

FIG. 3C is an enlarged view of detail B of FIG. 3A illustrating details of the cutting tool geometry. FIG. 3C shows how the tool bit is ground so that it may both face and turn for general work. It is very convenient to be able to turn and face with the same tool. The tool bit is sharpened so as to provide small negative cutting edge angles 396 and 397. The side cutting edge angle is 396 and the end cutting edge angle is 397. Using two negative cutting edge angles allows the tool to both turn and face. At the end of a turning cut, the tool can be backed out to create a square shoulder. Negative cutting edge angles are common, especially with indexable carbide insert tools, but they are not as efficient as positive cutting edge angles. Angles 396 and 397 are created by the person sharpening the tool. These negative angles would typically be about 5°. If these angles are too small (in absolute value), there may be insufficient relief when making a cut. If these angles are too large, the tool may be unnecessarily compromised.

As will be seen in later examples, this tool bit may be sharpened so as to provide a positive side or end cutting edge angle for more efficient removal of material. A cutter with a positive cutting edge angle is more efficient, but can only turn or face depending on the way it is ground. Tool bit 300 is in contact with the cut portion of the work 375 and is backed off to the right somewhat from the shoulder 370 separating the cut from the uncut portion 360 for clarity.

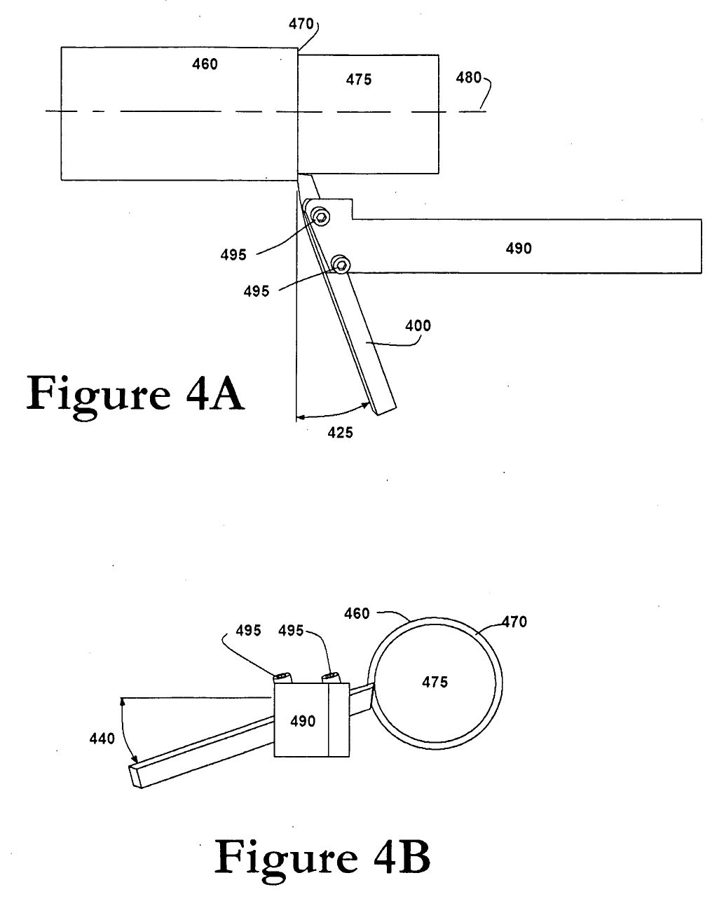

In the present invention, a positive plan angle allows the creation of the tool geometry shown in FIG. 3C by the creation of simple relatively easy-to-grind facets. The geometry shown in FIG. 3C by itself is not part of the present invention, but providing a plan angle that makes such geometry possible is part of the present invention. Note that the discussion of the detail view shown in FIG. 3C may be applied to the embodiments of FIGS. 4-7 as well.

FIG. 4A is a top view of a second embodiment of a toolholder of the present invention, illustrating an unorthodox version of this tool bit. FIG. 4B is a side view of a second embodiment of a toolholder of the present invention, illustrating an unorthodox version of this tool bit. As in the embodiment of FIGS. 3A and 3B, toolholder 490 incorporates a plan angle 425 of 20° and a symmetric rake plane tilted 20° from horizontal. Referring to FIGS. 4A and 4B, the axis of the shank of toolholder 490 may be parallel to the axis 480 of the lathe. Angle 440 is about 19.34°. This is the angle between the horizontal plane and an axis or edge of the tool bit 400 projected onto a plane that is perpendicular to the axis of the lathe, or in the case of FIG. 4B, the plane of the paper. This angle is derivative in the sense that it is completely determined by the plan angle and the two rake angles. It is shown to better clarify the overall geometry of the toolholder. Tool bit 400 may be secured to toolholder 480 via setscrews 495 or the like. Bit 400 shown is designed for turning from right to left and for facing. In the example of FIGS. 4A and 4B, tool bit 400 is turning bar stock 460 to reduce the diameter of the bar stock as shown in portion 475. The cutting takes place at the transition 470 between the uncut bar stock 460 and the reduced portion 475.

Although the shank of a boring tool may be held so that its axis is parallel to the axis of the lathe, it is virtually universal practice, when using a quick-change tool post, for the shank of turning and facing tools to be held so that the axis of the shank is perpendicular to the axis of the lathe. In FIGS. 4A and 4B, the axis of the shank of the toolholder is held parallel to the axis of the lathe. This may be undesirable to the extent that a greater portion of the toolholder is close to the work and may create clearance problems. An interesting observation is that the toolholder in FIGS. 4A and 4B, when clamped so that its shank is perpendicular to the axis of the lathe may be used as a nearly axial toolholder that cuts from left to right. This is, as far as the orientation of the tool bit, a mirror image of the toolholder depicted in FIGS. 7A and 7B. The embodiment of this invention shown in FIGS. 4A and 4B is suitable for use with a quick-change tool post.

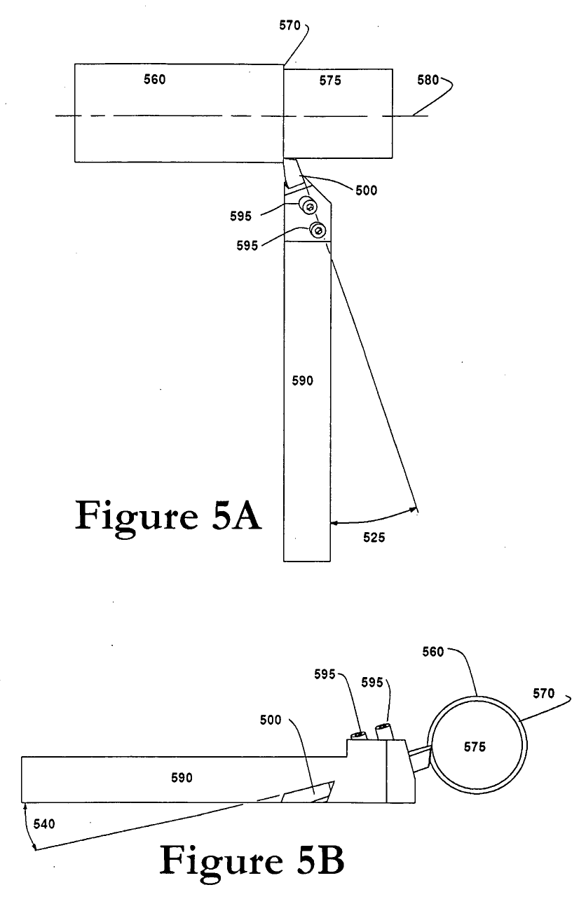

FIG. 5A is a top view and FIG. 5B is a side view of a third embodiment of a toolholder of the present invention, illustrating a toolholder that incorporates a plan angle 525 of 20° and a symmetric rake plane tilted 20° from horizontal. Referring to FIGS. 5A and 5B, the axis of toolholder 590 may be perpendicular relative to the axis 580 of the lathe. Angle 540 is about 19.34°. This is the angle between the horizontal plane and an axis or edge of the tool bit 500 projected onto a plane that is perpendicular to the axis of the lathe, or in the case of FIG. 5B, the plane of the paper. This angle is derivative in the sense that it is completely determined by the plan angle and the two rake angles. It is shown to better clarify the overall geometry of the toolholder. Tool bit 500 may be secured to toolholder 580 via setscrews 595 or the like. Bit 500 shown is designed for turning from right to left and for facing. In the example of FIGS. 5A and 5B, tool bit 500 is turning bar stock 560 to reduce the diameter of the bar stock as shown in portion 575. The cutting takes place at the transition 570 between the uncut bar stock 560 and the reduced portion 575.

In contrast to the other toolholders shown, the bit is held in a closed square hole that may be produced by a broach or similar means. The other toolholders illustrated herein feature open slots into which the bit may be inserted laterally. The toolholder of FIGS. 5A and 5B uses a half-length tool bit (e.g., approximately 1.25″ long) and demonstrates that the holder may be more compact and elegant looking if only half of the tool bit is used.

The toolholder in FIGS. 5A and 5B incorporates both side rake and back rake while maintaining a surprisingly conventional appearance. There are some disadvantages to this approach. First of all, the tool is used more wastefully, given the fact that it must be first cut in two and then, as always is the case with these toolholders, can only be partially used because some length is required for clamping. Second, the manufacturing of the toolholder is somewhat more complicated given the need to create a square hole. Third, access to the tool bit is limited because it is slid axially into its square hole. Therefore adjusting it along its axis is less simple. Fourth, if adequate clearance is provided for facing, the toolholder material will be very thin to the left of the tool bit where it emerges from the toolholder. Finally, the setscrews are inclined back toward the tool block that holds the toolholder, necessitating that the point of the tool be farther from the front of the tool block than might be desirable. Of course the toolholder may be removed from the tool block, the setscrews may be adjusted, and the toolholder may be returned to the tool block. This however complicates sharpening and adjusting the tool. The toolholder of FIGS. 5A and 5 B would work well with a lantern style tool post because a longer tool bit could be used and there would be no concerns about the accessibility of set screws 595.

FIG. 6A is a top view and FIG. 6B is a side view of a fourth embodiment of a toolholder of the present invention, illustrating a toolholder that incorporates a plan angle 625 of 45° and a symmetric rake plane tilted 20° from horizontal. Referring to FIGS. 6A and 6B, the axis of toolholder 690 may be perpendicular relative to the axis 680 of the lathe. Angle 640 is about 27.24°. This is the angle between the horizontal plane and an axis or edge of the tool bit 600 projected onto a plane that is perpendicular to the axis of the lathe, or in the case of FIG. 6B, the plane of the paper. This angle is derivative in the sense that it is completely determined by the plan angle and the two rake angles. It is shown to better clarify the overall geometry of the toolholder. Tool bit 600 may be secured to toolholder 680 via setscrews 695 or the like. Bit 600 shown is designed for turning from right to left and for facing. In the example of FIGS. 6A and 6B, tool bit 600 is turning bar stock 660 to reduce the diameter of the bar stock as shown in portion 675. The cutting takes place at the transition 670 between the uncut bar stock 660 and the reduced portion 675.

In the embodiment of FIGS. 6A and 6B, the toolholder incorporates a plan angle 625 of 45°. If the side rake and back rake are equal, as they happen to be in all of these examples, this embodiment could be considered the “natural” embodiment for this toolholder. The reason for this is that the tool bit is not rotated around its axis. The heel of the tool bit is simply lowered by angle 640 creating both side and back rake.

In Tucker, U.S. Pat. No. 3,382,746, incorporated herein by reference, the plan angle is 35°. The rake plane associated with the toolholder of that patent is horizontal, however, and thus no side rake or back rake is incorporated into the design.

Because the tool bit is not rotated around its axis, the 45° embodiment of the present invention is somewhat simpler to machine than other embodiments, and a crude version may be more easily fabricated. This version is the simplest to sharpen because the two facets involved are typically symmetric around a vertical plane that includes the axis of the tool bit. Furthermore, neither facet is shallow; therefore both are easy to grind. Nevertheless, this embodiment is not ideal for use with a quick-change tool post because the heel of the tool bit (assuming a new tool bit that has not been shortened is being used) backs up against the tool post thus rendering the point of the tool excessively far from the center of the tool post. This embodiment is, however, well adapted to a lantern-style tool post.

FIG. 7A is a top view and FIG. 7B is a side view of a fifth embodiment of a toolholder of the present invention, illustrating a toolholder that incorporates a plan angle 725 of 70° and a symmetric rake plane tilted 20° from horizontal. Referring to FIGS. 7A and 7B, the axis of toolholder 790 may be perpendicular relative to the axis 780 of the lathe. Angle 740 is about 43.96°. This is the angle between the horizontal plane and an axis or edge of the tool bit 700 projected onto a plane that is perpendicular to the axis of the lathe, or in the case of FIG. 7B, the plane of the paper. This angle is derivative in the sense that it is completely determined by the plan angle and the two rake angles. It is shown to better clarify the overall geometry of the toolholder. Tool bit 700 may be secured to toolholder 780 via setscrews 795 or the like. Bit 700 shown is designed for turning from right to left and for facing. In the example of FIGS. 7A and 7B, tool bit 700 is turning bar stock 760 to reduce the diameter of the bar stock as shown in portion 775. The cutting takes place at the transition 770 between the uncut bar stock 760 and the reduced portion 775. A left surface of the toolholder near the bit 785 may be perpendicular to the axis of the lathe (typically vertical) to allow for easy adjustment of the stick-out or protrusion of the tool bit.

The embodiment of FIGS. 7A and 7B may be referred to as a nearly axial toolholder. This embodiment is very unorthodox among lathe tools. Perhaps this is in part because such a toolholder would not be well suited to facing a part that was being held by a live center or a dead center in the tail stock. When a center is used in the tailstock a relatively small conical hole is established in the end of the part, and a cone-shaped support is forced into that hole for support. The cone-shaped support is often part of a somewhat bulky device that includes ball bearings. In actual use, however, most turning involves parts that are held in the lathe chuck and do not require the use of a center in the tailstock. The embodiment of FIGS. 7A and 7B allows for the tip of the tool to be relatively close to the center of the quick-change tool post. In this embodiment, the bit may be easier to sharpen than in the embodiments that have a plan angle of 20°. As the shallower facet may be smaller, given the fact that operators are likely to take a deeper turning cut than they would a facing cut, and in this case the facet used in turning is less shallow. This embodiment also facilitates the very important adjustment of the height of the nose or tip of the tool. A spacer of predetermined standard thickness may be used to establish the distance between a reference surface perpendicular to the axis of the lathe such as the end of a faced work piece and side 785 of the toolholder. After the distance has been established, the tool bit protrusion or stick-out can be fixed by sliding the bit along the groove or other constraining portion of the clamping part of the toolholder until the tool bit is seated in the toolholder and touching the reference surface. The height of the tool block that holds the toolholder is adjusted when the tool bit is protruding a standard amount. The height of the tool bit is a function of its stick-out. Therefore, after each subsequent sharpening, height will be reset when the stick-out is established at the standard distance. Another advantage of this embodiment is that it allows the toolholder to be machined from a relatively small block of material thus facilitating economical commercial production.

All of the aforesaid embodiments and the many intermediate embodiments not shown may be adapted to work with a variety of different sized tool bits. They may also be used with tool bits of a variety of cross-sections. The tool bit used however should have a flat surface parallel to the axis of the bit that will act as the rake face. If one were to use, for example, a round (cylindrical) tool bit, a flat surface parallel to the axis of the bit may have to be ground prior to installation of the bit into the toolholder. A bit of triangular cross section is a particularly attractive option. One flat face can serve as the rake face and the other two faces can fit in a mating groove, thus establishing a very firm location of the tool bit. A triangular bit may be easier to sharpen because less material would need to be removed to create usable facets. Unfortunately, bits of triangular cross section are not standard at the present time. However, the toolholder of the present invention may make such triangular bits more attractive to produce.

Most of the examples illustrated in the present application depict a relatively simple method for securing the tool bit. The tool bit is inserted into a slot, and constrained by two or more setscrews bearing on the upper surface of the tool bit. The invention is not limited to this method of constraint, but applies to toolholders that use any other method, a great variety of which are in use, for constraining the tool bit. The simple slot and set screw method is inexpensive to produce and adequate in the embodiments considered. However other securing means may be used within the spirit and scope of the present invention.

In the previous five embodiments of the toolholder, it is possible to use negative side cutting and end cutting angles so that the tool may be used to turn or to face. Being able to face and turn with the same bit is a great timesaver because the user is not required to change the tool block or tool bit when switching from one operation to another. If, on the other hand one wants to turn or face more efficiently, for example in a production environment, the cutter may be provided with a positive cutting edge angle for turning or for facing.

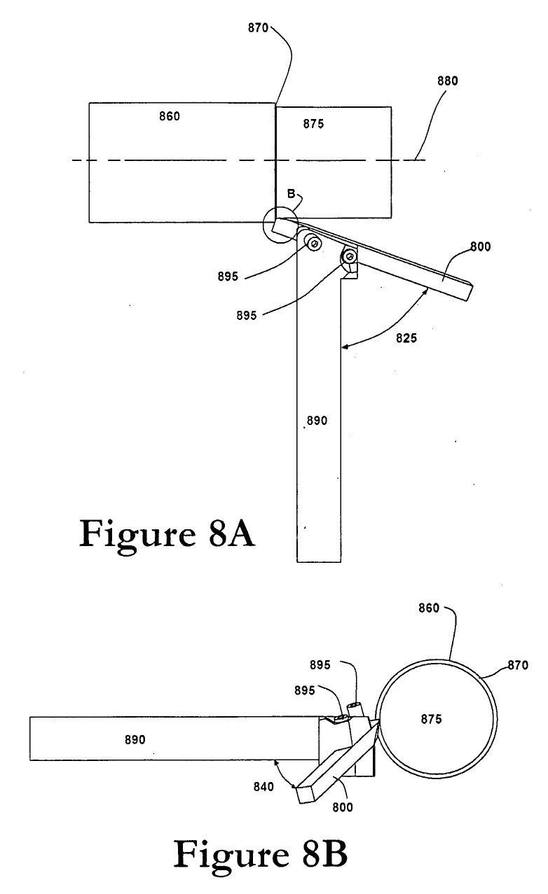

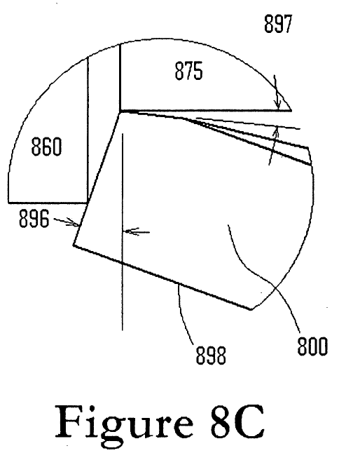

FIG. 8A is a top view and FIG. 8B is a side view of a sixth embodiment of a toolholder of the present invention, identical to the fifth embodiment shown in FIGS. 7A and 7B except for the manner in which the tool bit is sharpened. This embodiment, as in FIGS. 7A and 7B, incorporates a plan angle 825 of approximately 20° and a symmetric rake plane tilted 20° from horizontal. Angle 840 is about 43.96°. This is the angle between the horizontal plane and an axis or edge of the tool bit 800 projected onto a plane that is perpendicular to the axis of the lathe, or in the case of FIG. 8B, the plane of the paper. This angle is derivative in the sense that it is completely determined by the plan angle and the two rake angles. It is shown to better clarify the overall geometry of the toolholder.

Referring to FIGS. 8A and 8B, the axis of the elongated base of toolholder 890 may be perpendicular relative to the axis 880 of the lathe. Tool bit 800 may be secured to toolholder 890 via setscrews 895 or the like. Bit 880 shown is designed for turning from right to left and not for facing. In the example of FIGS. 8A and 8B, tool bit 800 is turning bar stock 860 to reduce the diameter of the bar stock as shown in portion 875. The cutting takes place at the transition 870 between the uncut bar stock 860 and the reduced portion 875.

The bit in this sixth embodiment is ground to provide a positive side cutting edge angle of about 20° for efficient turning. One is able to remove a great deal more material per unit time with this bit configuration. On the other hand, such an embodiment makes it impossible to turn and face with the same tool in the same orientation.

Detail B of FIG. 8A shown in FIG. 8C shows a tool bit 800 with positive side cutting edge angle 896 of about 20° for more efficient turning. The end cutting edge angle remains at minus 5°. The bit is cutting from right to left. The cut portion of the work piece is 875 and the uncut portion is 860. The user can select various cutting edge angles depending on his needs. The particular angle shown in detail B is very effective, and easy to grind by eye, because it is perpendicular to the axis or an edge 898 of the tool.

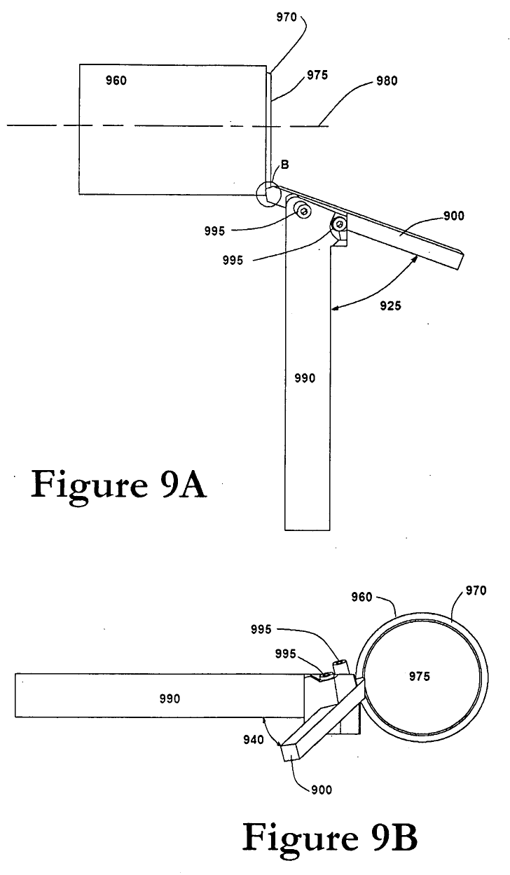

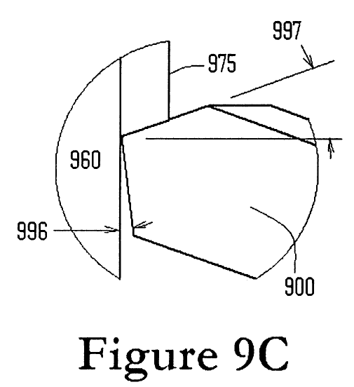

FIG. 9A is a top view and FIG. 9B is a side view of a seventh embodiment of a toolholder of the present invention, identical to the fifth embodiment shown in FIGS. 7A and 7B except for the manner in which the tool bit is sharpened. This embodiment, as in FIGS. 7A and 7B, incorporates a plan angle 925 of approximately 20° and a symmetric rake plane tilted 20° from horizontal. Angle 940 is about 43.96°. This is the angle between the horizontal plane and an axis or edge of the tool bit 900 projected onto a plane that is perpendicular to the axis of the lathe, or in the case of FIG. 9B, the plane of the paper. This angle is derivative in the sense that it is completely determined by the plan angle and the two rake angles. It is shown to better clarify the overall geometry of the toolholder.

Referring to FIGS. 9A and 9B, the axis of the elongated base of toolholder 990 may be perpendicular relative to the axis 980 of the lathe. Tool bit 900 may be secured to toolholder 990 via setscrews 995 or the like. Bit 980 shown is designed for facing and not for turning. In the example of FIGS. 9A and 9B, tool bit 900 is turning bar stock 960 to reduce the diameter of the bar stock as shown in portion 975. The cutting takes place at the transition 970 between the uncut bar stock 960 and the reduced portion 975.

FIGS. 9A-C shows a facing cut with the bit ground to provide a positive end cutting edge angle. Detail B of FIG. 9A shown in FIG. 9C illustrates a tool bit 900 with side cutting edge angle 996 of minus 5° for clearance. The end cutting edge angle 997 is about positive 20 degrees. The bit is moving from the outside of the work piece toward the center. The cut portion of the work piece is 975 and the uncut portion is 960. The user can select various cutting edge angles depending on his needs. The particular angle shown in detail B is very effective is easy to grind. One is able to remove a great deal more material per unit time with this bit configuration. On the other hand, such an embodiment makes it impossible to turn and face with the same tool in the same orientation.

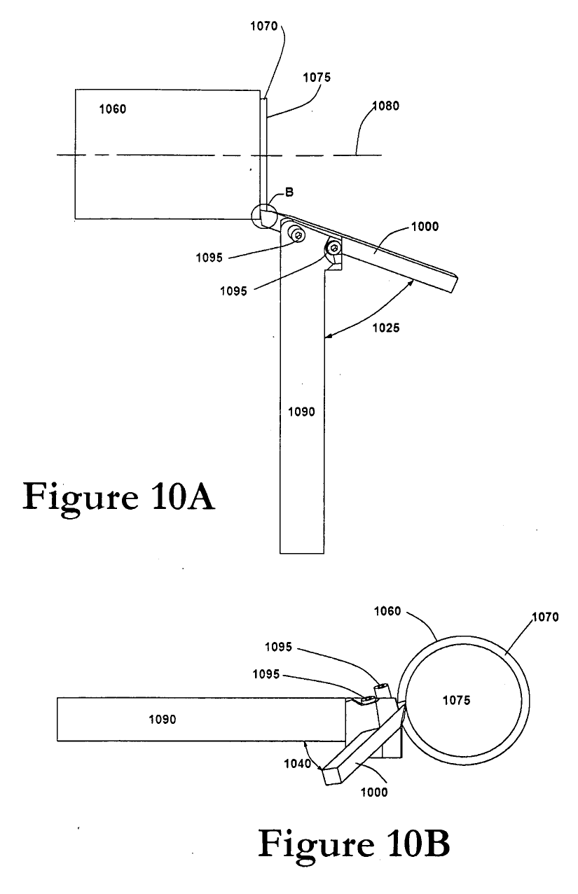

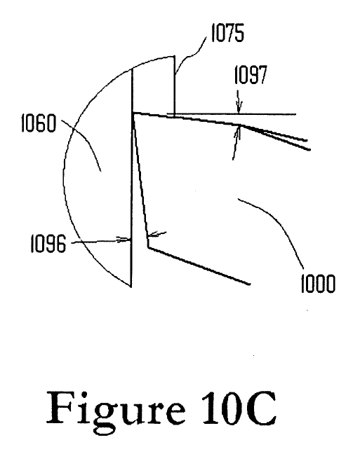

FIG. 10A is a top view and FIG. 10B is a side view of an eighth embodiment of a toolholder of the present invention, identical to the fifth embodiment shown in FIGS. 7A and 7B except for the fact that the tool is facing rather than turning. The bit is identical to that shown in FIGS. 7A and 7B. This embodiment, as in FIGS. 7A and 7B, incorporates a plan angle 1025 of approximately 20° and a symmetric rake plane tilted 20° from horizontal. Angle 1040 is about 43.96°. This is the angle between the horizontal plane and an axis or edge of the tool bit 1000 projected onto a plane that is perpendicular to the axis of the lathe, or in the case of FIG. 10B, the plane of the paper. This angle is derivative in the sense that it is completely determined by the plan angle and the two rake angles. It is shown to better clarify the overall geometry of the toolholder.

Referring to FIGS. 10A and 10B, the axis of the elongated base of toolholder 1090 may be perpendicular relative to the axis 1080 of the lathe. Tool bit 1000 may be secured to toolholder 1090 via setscrews 1095 or the like. Bit 1080 shown is designed for turning from right to left and for facing. In the example of FIGS. 10A and 10B, tool bit 1000 is facing bar stock 1060 to reduce the diameter of the bar stock as shown in portion 1075. FIGS. 10A-C show a facing cut with a bit that has been sharpened to provide a negative 5° end cutting edge angle, and negative side cutting angle thus enabling facing and turning to be done with a single toolholder in a single orientation.

Detail B of FIG. 10A shown in FIG. 10C illustrates how the tool bit has been ground so that it can both face and turn for general work. This is the same geometry shown in FIGS. 3 through 7. FIGS. 10A-C demonstrate the process of facing with the geometry shown turning in the other figures. It is very convenient to be able to turn and face with the same tool. The tool bit is sharpened so as to provide small negative cutting edge angles 1096 and 1097. The side cutting edge angle 1096 provides clearance while facing. The end cutting edge angle is 1097. Using two negative cutting edge angles allows the tool to both turn and face. At the end of the facing cut, the tool can be moved to the right to create a square shoulder. Negative cutting edge angles are common, especially in indexable carbide insert tools, but they are not as efficient as positive cutting edge angles. Angles 1096 and 1097 are created by the person sharpening the tool. These angles would typically be about 5°. If these angles are too small (in absolute value), there may be insufficient clearance when making a cut. If these angles are too large, the tool may be unnecessarily compromised.

The toolholders demonstrated thus far allow for the accommodation of an entire tool bit. In the smaller sizes, these tool bits are typically 2½ inches long. Accommodating such a long tool bit is desirable because it makes maximal use of the tool bit. More compact and possibly somewhat simpler designs may be produced if shorter tool bits are used.

The examples previously discussed illustrate how the present invention may be utilized in a number of preferred embodiments. However, the specific angles discussed should not be construed as limited the spirit and scope of the present invention in any way. The plan angle, the side rake angle, and the back rake angle to define the geometry of each toolholder. The latter two angles define the rake plane, and the rake plane in combination with the plan angle completely defines the orientation of the tool bit. Rake angle, for example, while described as having specific values in the various embodiments, may vary from substantially 6 to substantially 30 degrees within the spirit and scope of the present invention. The preferred embodiment may have a plan angle of approximately 70 degrees, and side rake and back rake angles of approximately 14.43 degrees each, as derived from a symmetric rake plane that is inclined approximately 20° from the horizontal. This embodiment may be suitable for cutting many steel and Aluminum alloys. Table 1 below sets forth some further examples of desirable angle ranges for the various embodiments presented herein.

TABLE 1

| | | | | Angles (degrees) | | |
|---|---|---|---|---|---|---|
| | Description | | | Plan | Side | Back |
| | Shank | | | Angle | Rake | Rake |
| FIG. | Orientation | Bit Location | Other | Range | Range | range |
| 3 | perpendicular to | left of shank of | | 10-30 | 6-30 | 6-30 |
| | axis of lathe | tool holder | | | | |
| 4 | parallel to axis of | left of shank of | | 10-30 | 6-30 | 6-30 |
| | lathe | tool holder | | | | |
| 5 | perpendicular to | emerges from the | narrow aspect | 10-30 | 6-30 | 6-30 |
| | axis of lathe | end of the narrow | holder | | | |
| | | holder | | | | |
| 6 | perpendicular to | end of the tool | | 30-60 | 6-30 | 6-30 |
| | axis of lathe | holder | | | | |
| 7 | perpendicular to | end of the tool | | 60-80 | 6-30 | 6-30 |
| | axis of lathe | holder | | | | |

Whereas preferred embodiments and various alternative embodiments of the invention have been disclosed and described in detail herein, it may be apparent to those skilled in the art that various changes in form and detail may be made therein without departing from the spirit and scope thereof.

I claim:

1. A lathe toolholder for use with an elongated straight tool bit of uniform cross-section, made of metal-cutting material, having simplified cutting tip geometry, for use on a lathe turning a work piece around an axis of the lathe, the toolholder comprising:
an elongated base portion adapted to fit into a lathe tool post, and
a tool bit clamping portion, formed at one end of the elongated base portion, adapted to clamp the tool bit having a simplified cutting tip,
wherein the tool bit clamping portion clamps the tool bit in such a way as to use an existing unmodified side of the tool bit as a rake face, said rake face having fixed side rake and fixed back rake.

2. The lathe toolholder of claim 1, wherein the tool bit comprises an elongated straight piece of metal-cutting material having a uniform cross-section of substantially an N-sided polygon along its axis, and where one end of the tool bit is ground into a simplified cutting tip, the simplified cutting tip comprising:
N undisturbed long sides of the tool bit, an upper one of which serves as the rake face;
a first facet formed on the one end of the tool bit serving as a principal flank defined by selected relief angle and side cutting edge angle; and
a second facet, formed on the one end of the tool bit, serving as an auxiliary flank defined by selected relief angle and end cutting edge angle.

3. The lathe toolholder of claim 2, wherein the tool bit comprises an elongated straight piece of metal-cutting material having a uniform and substantially rectangular cross-section along its axis, and where one end of the tool bit is ground into a simplified cutting tip, the simplified cutting tip comprising:
four undisturbed long sides of the tool bit, an upper one of which serves as the rake face;
a first facet formed on the one end of the tool bit serving as the principal flank defined by selected relief angle and side cutting edge angle; and
a second facet, formed on the one end of the tool bit, serving as the auxiliary flank defined by selected relief angle and end cutting edge angle.

4. The lathe toolholder of claim 2, wherein simplified cutting tip geometry comprises first and second selected relief angles that are substantially equal to one another.

5. The lathe toolholder of claim 4, wherein the first and second selected relief angles are both within the range of substantially 5 to 14 degrees.

6. The lathe toolholder of claim 5, wherein the first and second selected relief angles are both substantially 7 degrees.

7. The lathe toolholder of claim 2, wherein the first and second selected cutting edge angles are both substantially −5 degrees.

8. The lathe toolholder of claim 2, wherein orientation of the tool bit established by the toolholder comprises a plan angle, as measured from the axis of the tool bit to a plane perpendicular to the axis of the lathe, and projected onto a horizontal plane, wherein the plan angle allows for positive and negative side and end cutting edge angles as small as substantially −5° to be produced by grinding a simple facet on the end of the tool bit.

9. The lathe toolholder of claim 2, wherein orientation of the tool bit established by the toolholder comprises a plan angle, as measured from the axis of the tool bit to a plane perpendicular to the axis of the lathe, and projected onto a horizontal plane, wherein the plan angle ranges from substantially 20 degrees to substantially 70 degrees.

10. The lathe toolholder of claim 2, wherein orientation of the tool bit established by the toolholder comprises a plan angle, as measured from the axis of the tool bit to a plane perpendicular to the axis of the lathe, and projected onto a horizontal plane, wherein the plan angle is substantially 20 degrees.

11. The lathe toolholder of claim 2, wherein orientation of the tool bit established by the toolholder comprises a plan angle, as measured from the axis of the tool bit to a plane perpendicular to the axis of the lathe, and projected onto a horizontal plane, wherein the plan angle is substantially 45 degrees.

12. The lathe toolholder of claim 2, wherein orientation of the tool bit established by the toolholder comprises a plan angle, as measured from the axis of the tool bit to a plane perpendicular to the axis of the lathe, and projected onto a horizontal plane, wherein the plan angle is substantially 70 degrees.

13. The lathe toolholder of claim 12, wherein a side of the toolholder near the cutting tip of the tool bit is perpendicular to the axis of the lathe thus facilitating adjustment of the stick-out of the tool bit and the height of the cutting tip when used in conjunction with a reference surface on the lathe or work piece and a standard spacer.

14. The toolholder of claim 2, wherein plan angle, as measured from axis of the tool bit to a plane perpendicular to the axis of the lathe, and projected onto a horizontal plane, having been selected, the clamping portion of the toolholder constrains the tool bit so as to allow the unmodified upper side of the tool bit to serve as the rake surface possessing positive side rake and positive back rake by ensuring that the heel of the tool bit is lower than the tip, and rotating the tool bit around its axis, the direction and amount of rotation depending upon the plan angle selected and desired side rake and back rake angles.

15. The lathe toolholder of claim 2, wherein the tool bit clamping portion of the holder orients the tool bit so that the side rake and back rake associated with the upper surface of the tool bit are substantially equal.

16. The lathe toolholder of claim 2, wherein the tool bit clamping portion of the holder constrains or orients the tool bit so that the side rake angle and back rake angle associated with the upper surface of the tool bit range from substantially 6 degrees to substantially 30 degrees.

17. The lathe toolholder of claim 15, wherein the tool bit clamping portion of the holder orients the tool bit so that the side rake angle and back rake angle associated with the upper surface of the tool bit range from substantially 6 degrees to substantially 30 degrees.

18. The lathe toolholder of claim 15, wherein the tool bit clamping portion of the holder constrains or orients the tool bit so that the side rake and back rake associated with the upper surface of the tool bit are substantially 14.43 degrees.

19. The toolholder of claim 8, wherein plan angle, as measured from the axis of the tool bit to a plane perpendicular to the axis of the lathe, and projected onto a horizontal plane, having been selected, the clamping portion of the toolholder constrains the tool bit so as to allow the unmodified upper side of the tool bit to serve as the rake surface possessing positive side rake and positive back rake by ensuring that the heel of the tool bit is lower than the tip, and rotating the tool bit around its axis, the direction and amount of rotation depending upon the plan angle selected and desired side rake and back rake angles.

20. The toolholder of claim 9, wherein plan angle, as measured from the axis of the tool bit to a plane perpendicular to the axis of the lathe, and projected onto a horizontal plane, having been selected, the clamping portion of the toolholder constrains the tool bit so as to allow the unmodified upper side of the tool bit to serve as the rake surface possessing positive side rake and positive back rake by ensuring that the heel of the tool bit is lower than the tip, and rotating the tool bit around its axis, the direction and amount of rotation depending upon the plan angle selected and desired side rake and back rake angles.

21. The toolholder of claim 10, wherein plan angle, as measured from the axis of the tool bit to a plane perpendicular to the axis of the lathe, and projected onto a horizontal plane, having been selected, the clamping portion of the toolholder constrains the tool bit so as to allow the unmodified upper side of the tool bit to serve as the rake surface possessing positive side rake and positive back rake by ensuring that the heel of the tool bit is lower than the tip, and rotating the tool bit around its axis, the direction and amount of rotation depending upon the plan angle selected and desired side rake and back rake angles.

22. The toolholder of claim 11, wherein plan angle, as measured from the axis of the tool bit to a plane perpendicular to the axis of the lathe, and projected onto a horizontal plane, having been selected, the clamping portion of the toolholder constrains the tool bit so as to allow the unmodified upper side of the tool bit to serve as the rake surface possessing positive side rake and positive back rake by ensuring that the heel of the tool bit is lower than the tip, and rotating the tool bit around its axis, the direction and amount of rotation depending upon the plan angle selected and desired side rake and back rake angles.

23. The toolholder of claim 12, wherein plan angle, as measured from the axis of the tool bit to a plane substantially perpendicular to the axis of the lathe, and projected onto a horizontal plane, having been selected, the clamping portion of the toolholder constrains the tool bit so as to allow the unmodified upper side of the tool bit to serve as the rake surface possessing positive side rake and positive back rake by ensuring that the heel of the tool bit is lower than the tip, and rotating the tool bit around its axis, the direction and amount of rotation depending upon the plan angle selected and desired side rake and back rake angles.

24. The lathe toolholder of claim 1, wherein the elongated base portion adapted to fit into a lathe tool post is substantially perpendicular to the axis of the lathe,
the tool bit clamping portion clamps the tool bit such that the tool bit extends from a left portion of the tool holder on an end of the lathe closer to the axis of the lathe;
the plan angle ranges from substantially 10 degrees to substantially 30 degrees;
the side rake angle ranges from substantially 6 degrees to substantially 30 degrees; and
the back rake angle ranges from substantially 6 degrees to substantially 30 degrees.

25. The lathe toolholder of claim 1, wherein the elongated base portion adapted to fit into a lathe tool post is substantially parallel to the axis of the lathe,
the tool bit clamping portion clamps the tool bit such that the tool bit extends from a left portion of the tool holder;
the plan angle ranges from substantially 10 degrees to substantially 30 degrees;
the side rake angle ranges from substantially 6 degrees to substantially 30 degrees; and
the back rake angle ranges from substantially 6 degrees to substantially 30 degrees.

26. The lathe toolholder of claim 1, wherein the elongated base portion adapted to fit into a lathe tool post is substantially perpendicular to the axis of the lathe,
the tool bit clamping portion clamps the tool bit such that the tool bit extends from an end portion of the tool holder closer to the axis of the lathe;
the plan angle ranges from substantially 10 degrees to substantially 30 degrees;
the side rake angle ranges from substantially 6 degrees to substantially 30 degrees; and
the back rake angle ranges from substantially 6 degrees to substantially 30 degrees.

27. The lathe toolholder of claim 1, wherein the elongated base portion adapted to fit into a lathe tool post is substantially perpendicular to the axis of the lathe,
the tool bit clamping portion clamps the tool bit such that the tool bit extends from an end portion of the tool holder closer to the axis of the lathe;
the plan angle ranges from substantially 30 degrees to substantially 60 degrees;
the side rake angle ranges from substantially 6 degrees to substantially 30 degrees; and
the back rake angle ranges from substantially 6 degrees to substantially 30 degrees.

28. The lathe toolholder of claim 1, wherein the elongated base portion adapted to fit into a lathe tool post is substantially perpendicular to the axis of the lathe,
the tool bit clamping portion clamps the tool bit such that the tool bit extends from an end portion of the tool holder closer to the axis of the lathe;
the plan angle ranges from substantially 60 degrees to substantially 80 degrees;
the side rake angle ranges from substantially 6 degrees to substantially 30 degrees; and
the back rake angle ranges from substantially 6 degrees to substantially 30 degrees.
